(19) United States
(12) Patent Application Publication
(10) Pub. No.: US 2014/0207703 A1
(43) Pub. Date: Jul. 24, 2014

(54) System and Method for Providing Transit Reviews

(71) Applicant: Zhiheng HUANG, Sunnyvale, CA (US)

(72) Inventor: Zhiheng HUANG, Sunnyvale, CA (US)

(21) Appl. No.: 14/153,490

(22) Filed: Jan. 13, 2014

Related U.S. Application Data
(60) Provisional application No. 61/756,059, filed on Jan. 24, 2013.

(51) Int. Cl. G06Q 30/02

(52) U.S. Cl. CPC G06Q 30/0282
USPC 705/347

(57) ABSTRACT

A social transit review platform allows a user to create and share a transit review from a first subject to a second subject; the first and second subject being any product, service, venue, etc. The user first creates a personal user account, through which the transit review can be created. Upon creating the transit review, the user can also provide a first subject review or a second subject review for the first subject and second subject, respectively. Comparative review data is then provided by the user to describe the transition from the first subject to the second subject. The first subject review, second subject review, and comparative review data are then organized into the transit review and displayed to other users. A quick transit review can also be generated, to display a number of positive transit reviews and a number of negative transit reviews for a collection of transit reviews.

The current application claims a priority to the U.S. Provisional Patent application serial number 61/756,059 filed on Jan. 24, 2013.

### FIELD OF THE INVENTION

The present invention relates generally to a software application. Furthermore, the present invention relates to a software application for providing social reviews of commercial products and services. Additionally, the present invention relates to the comparison of commercial products and services.

### BACKGROUND OF THE INVENTION

Consumer reviews are a very valuable resource when it comes to purchasing new products, trying new restaurants, choosing a service provider, etc. People want an idea of what to expect when they are trying something for the first time. No one wants to make a large investment into a product or service and be returned with lackluster results. Traditionally, consumer reviews are brought around by word of mouth. Friends and family will share their experiences pertaining to certain products or services with others. Often times this is helpful as individuals will offer comparisons of their previous experiences with other similar products or services.

Today, however, many consumer reviews are performed online on company websites, forums and other forms of internet media. As they are online, these reviews are easily accessible to a diverse population. People can create and view thousands of product reviews with the click of a button. However, these reviews are often found on different websites thus making it a hassle for individuals to find, sort through and analyze reviews for different products of the same genre. Additionally, there is no way of easily accessing reviews of the transitions from one product to the next. Comparative reviews can be very helpful in understanding major differences between products and services that might not be initially apparent. These reviews can help an individual to better understand what to expect during the transition phase.

Therefore it is the object of the present invention to provide a social review platform in which users can create both individual product reviews and transit reviews. Individual product reviews allow a user to focus on a single item for review while transit reviews allow a user to compare two products and discuss their experience in the transition from one product to another. All transition ratings for a set of products are tallied, totaled and displayed to the user to be used as a quick reference as to the generally preferred product. Users can also provide comments on existing reviews as to provide further insight on a review or to indicate the helpfulness of a particular review. Friends lists can also be created to quickly share and comment on products belonging to select individuals.

### BRIEF DESCRIPTION OF THE DRAWINGS

FIG. 1 is a flowchart of the overall process for creating a transit review.

FIG. 2 is a diagram depicting the connection between the at least one host server and the plurality of user devices over the communication network.

FIG. 3a is a more detailed flowchart of the process for creating a transit review;

FIG. 3b is a continuation thereof;

FIG. 3c is a further continuation thereof.

FIG. 4 is a flowchart of the process for retrieving the first subject review.

FIG. 5 is a flowchart showing a first method of obtaining first product specifications.

FIG. 6 is a flowchart showing a second method of obtaining first product specifications.

FIG. 7 is a flowchart showing a third method of obtaining first product specifications.

FIG. 8 is a flowchart of the process for retrieving the second subject review.

FIG. 9 is a flowchart showing a first method of obtaining second product specifications.

FIG. 10 is a flowchart showing a second method of obtaining second product specifications.

FIG. 11 is a flowchart showing a third method of obtaining second product specifications.

FIG. 12a is a diagram depicting a display of the transit review;

FIG. 12b is a diagram depicting the first subject review thereof;

FIG. 12c is a diagram depicting the second subject review thereof;

FIG. 12d is a diagram depicting the comparative review data thereof.

FIG. 13 is a flowchart of the process for creating a comparative display within a quick transit review.

FIG. 14 is a first example of the display of the quick transit review.

FIG. 15 is a second example of the display of the quick transit review.

### DETAIL DESCRIPTIONS OF THE INVENTION

All illustrations of the drawings are for the purpose of describing selected versions of the present invention and are not intended to limit the scope of the present invention.

The present invention is a social transit review 52 platform that allows users to create and share subject reviews. The social transit review 52 platform utilizes a non-transitory computer-readable medium 11, a host website 21 and a communication network 31. The social transit review 52 platform allows a user to provide reviews on subjects such as consumer products and commercial services, and share said reviews with other users of the social transit review 52 platform. Reviews can be created for individual products or services, or for the transition from one product or service to another comparable product or service. In the preferred embodiment of the present invention the social transit review 52 platform is used to compare consumer products or services, however, the social transit review 52 platform can be used to compare any number of other services, locations, media, individuals, venues, music genres, etc.

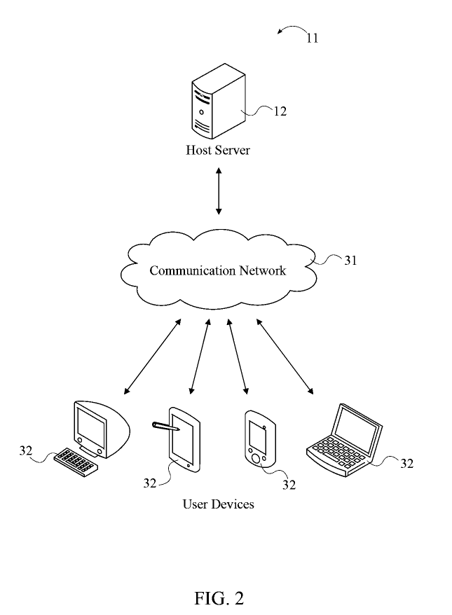

In the preferred embodiment of the present invention, the non-transitory computer readable medium is in the form of at least one host server 12. The at least one host server 12 is in communication with a plurality of user devices 32 via the communication network 31, as depicted in FIG. 2. Each of the plurality of user devices 32 can be any electronic device capable of connecting to the communication network 31, such as a cell phone, tablet, or computer. The communication network 31 can be any type of public or private network or combination of network types such as a local area network, wide area network, telephone network, the Internet, an intranet, etc. The at least one host server 12 is further comprised of a plurality of data stores. The plurality of data stores can be configured to store, access and manage information in any data format. In the preferred embodiment of the present invention the at least one host server 12 is used to store information in regards to lists of products, product details or specifications, personal user account 42s, product reviews and information in regards to the host website 21 infrastructure, however, any additional information may be stored on the at least one host server 12.

A plurality of user accounts 41 are stored on the at least one host server 12; each of the plurality of user accounts 41 pertaining to a unique user. Additionally, a collection of transit reviews 51 is stored on the at least one host server 12; the collection of transit reviews 51 being created by the plurality of user accounts 41. Through the host website 21, a user can create a personal user account 42 through which the user can interact with the at least one host server 12 in order to create a transit review 52 to be added to the collection of transit reviews 51.

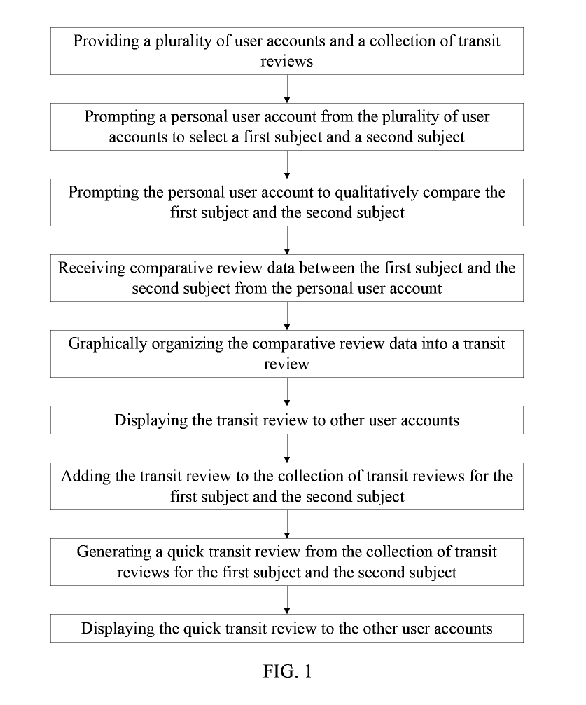

In reference to FIG. 1, in order to create the transit review 52, the personal user account 42 is first prompted to select a first subject 61 and a second subject 71. This task is relayed from the at least one host server 12 to the user through the host website 21. The first subject 61 and the second subject 71 should fall within the same scope of discussion for comparative reasons, as will become apparent. The following provides examples of different subject matter for which the first subject 61 and the second subject 71 can describe, and is not intended to limit the scope of subject matter: two different models or brands of computers, two home cleaning services, two music venues. The first subject 61 and the second subject 71 can be selected from a predefined list of products, services, etc. stored on the at least one host server 12, extracted from third party websites, or manually input into the at least one host server 12.

In further reference to FIG. 1, once the user has selected the first subject 61 and the second subject 71 through the personal user account 42, the at least one host server 12 prompts the personal user account 42 to qualitatively compare the first subject 61 and the second subject 71. Again, this task is facilitated to the user by the host website 21. A plurality of transition input fields is displayed to the user, allowing the user to submit comparative review data 53, such as the current date, a written description of the user's experience from transitioning between the first subject 61 and the second subject 71, and an overall transition rating. The overall transition rating represents the user's overall experience in transitioning from one product to another product, one service to another service, etc. In the preferred embodiment of the present invention, the overall transition rating is provided using a scale from one to five, however, it is possible for any other scale or rating method to be used. It is also possible for the plurality of transition input fields to be provided for the inclusion of any other relevant information in regards to the transition from the first subject 61 to the second subject 71.

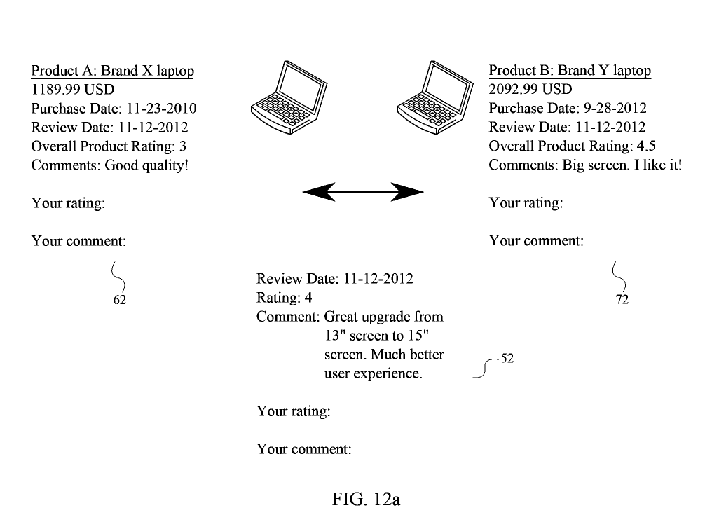

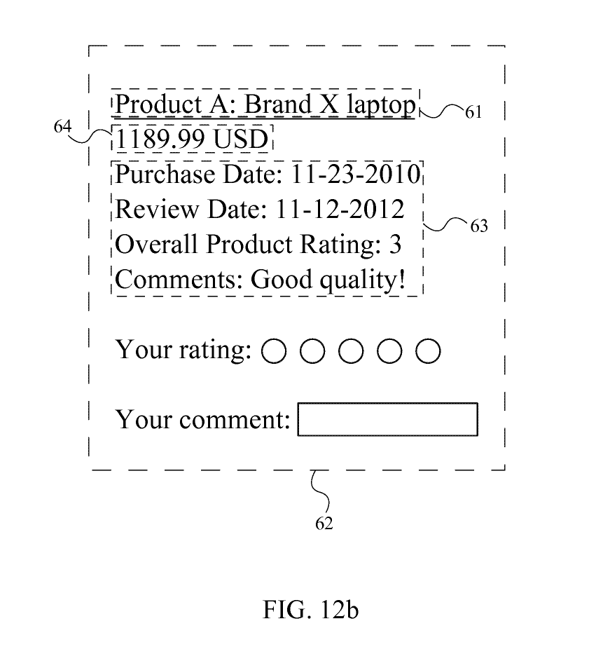

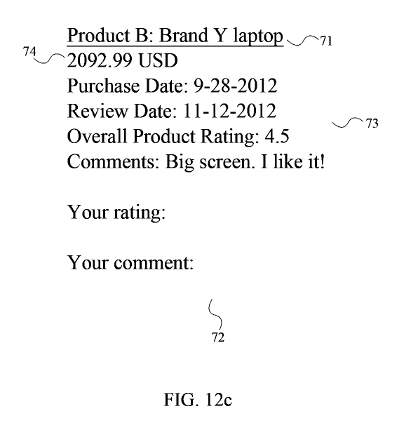

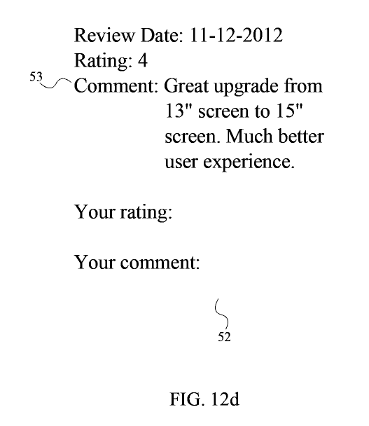

Upon receiving the comparative review data 53 between the first subject 61 and the second subject 71 from the personal user account 42, the at least one host server 12 graphically organizes the comparative review data 53 into the transit review 52, as depicted in FIG. 12d. The transit review 52 is then displayed to other user accounts 43, as depicted in FIG. 12a, and added to the collection of transit reviews 51 for the first subject 61 and the second subject 71. The user may elect to share the transit review 52 with all other users of the social transit review 52 platform or only a select group of friends. Once the transit review 52 has been shared, the other users can comment on the transit review 52 and provide an overall rating for the transit review 52 (i.e. to rate how helpful the transit review 52 was or to show if user's agree with the transit review 52).

A friends list of other users of the social transit review 52 platform can be created in order to readily share products with the select group of friends defined by the user. In addition to allowing the user to quickly share new transit review 52s and individual product/service/venue reviews with the select group of other users, the friends list allows the user to share a stored list of owned products/services used/venues attended. It is also possible for a user's list of owned products/services used/venues attended to be made publicly available to all other users. It may also be possible for the other users on the friends list of the user to receive updates or notifications when the user adds a new product/service/venue or review to the personal user account 42.

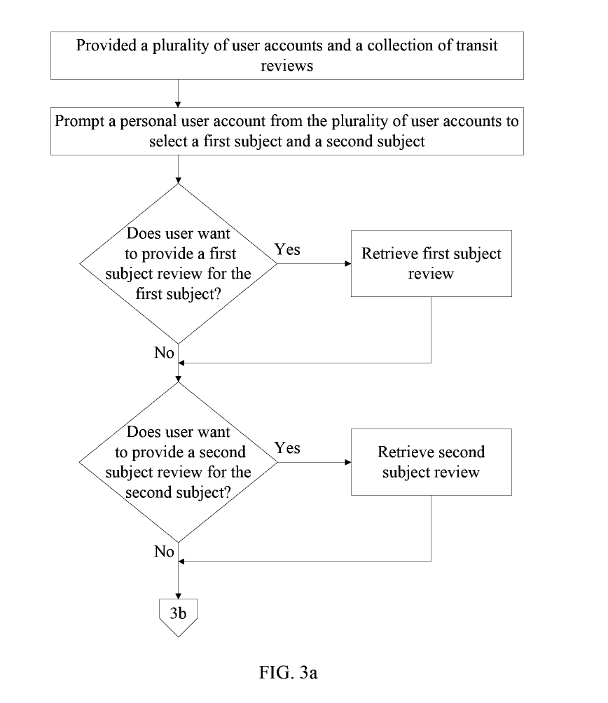

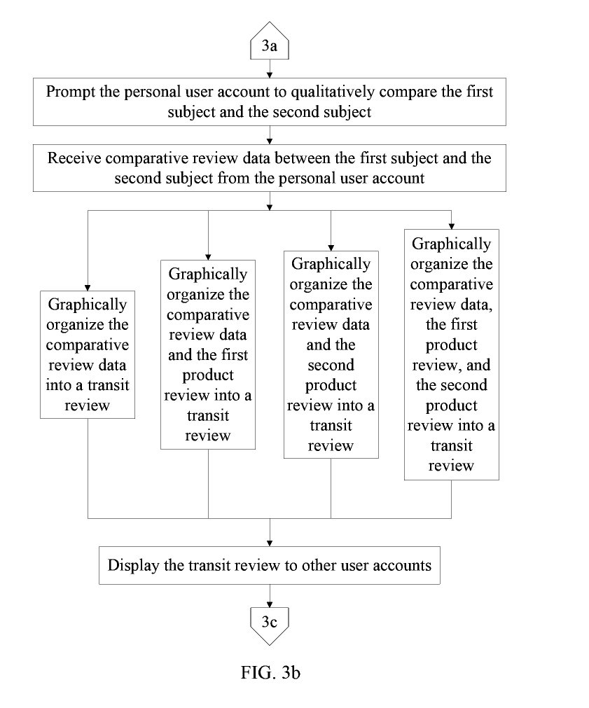

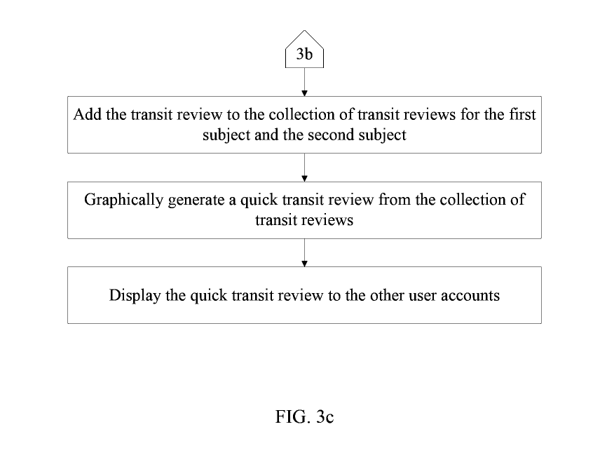

In reference to FIG. 3a-3c, when creating the transit review 52, the user may also choose to include a first subject review 62 of the first subject 61. The first subject review 62 can also be displayed standalone. Upon selecting the first subject 61, the user is prompted to decide whether or not he or she would like to provide the first subject review 62. If the first subject 61 has already been reviewed by the user, either standalone or as part of another transit review 52, and the user elects to provide the first subject review 62, then the first subject review 62 is retrieved by the at least one host server 12. The first subject review 62 is then graphically organized into the transit review 52, along with the comparative review data 53. If the first subject review 62 does not exist and the user elects to provide the first subject review 62, then the personal user account 42 is prompted to input first subject review data 63 for the first subject 61.

The creation of the first subject review 62 is facilitated by the host website 21. A plurality of first review input fields is displayed to the user, allowing the user to submit first subject review data 63, such as the current date, a written description of the user's experience with the first subject 61, and an overall first subject 61 rating. In the preferred embodiment of the present invention, the overall first subject 61 rating is provided using a scale from one to five, however, it is possible for any other scale or rating method to be used. It is also possible for the plurality of first review input fields to be provided for the inclusion of any other relevant information in regards to the user's experience with the first subject 61.

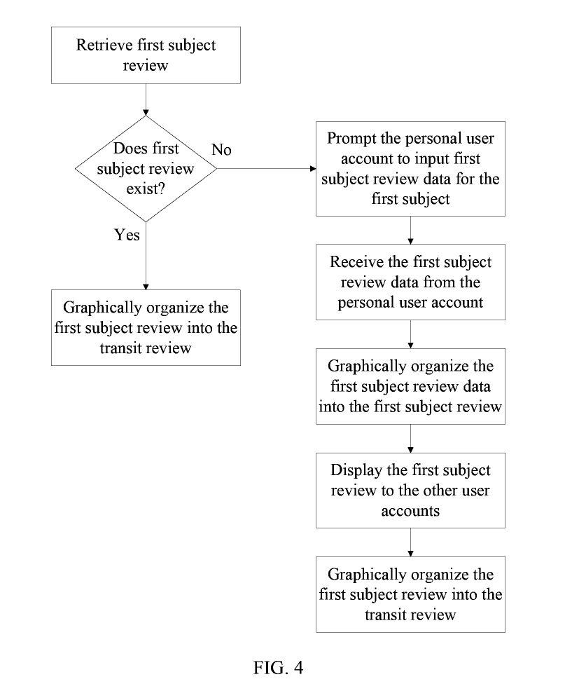

In reference to FIG. 4, upon receiving the first subject review data 63 for the first subject 61 from the personal user account 42, the at least one host server 12 graphically organizes the first subject review data 63 into the first subject review 62. The first subject review 62 is then stored on the at least one host server 12 or another memory device, and displayed to the other user accounts 43, as depicted in FIG. 12b. The user may elect to share the first subject review 62 with all other users of the social transit review 52 platform or only with the select group of friends on the friends list of the user. Once the first subject review 62 has been shared, the other users can comment on the first subject review 62 and provide an overall rating for the first subject review 62.

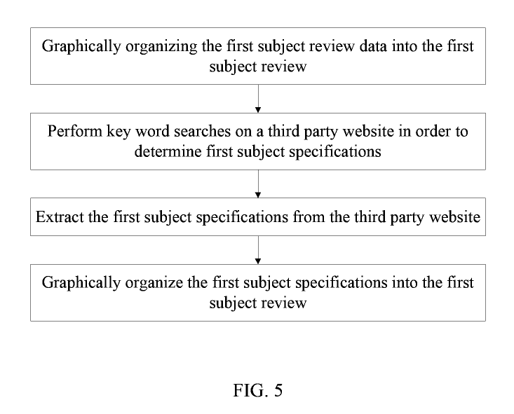

When creating the first subject review 62, first subject specifications 64 may also be gathered and employed. The at least one host server 12 graphically organizes the first subject specifications 64 into the first subject review 62 along with the first subject review data 63. The first subject specifications 64 can be gathered in three ways. In reference to FIG. 5, the first method of gathering the first subject specifications 64 includes performing key word searches on a third party website in order to determine the first subject specifications 64. When the first subject 61 is discovered on the third party website, the key word searches are performed in order to determine the first subject specifications 64 that are desired, such as the dimensions of a product, location of a venue, or service radius of a business. Once keywords are discovered, the at least one host server 12 extracts the first subject specifications 64 from the third party website and graphically organizes the first subject specifications 64 into the first review along with the first subject review data 63.

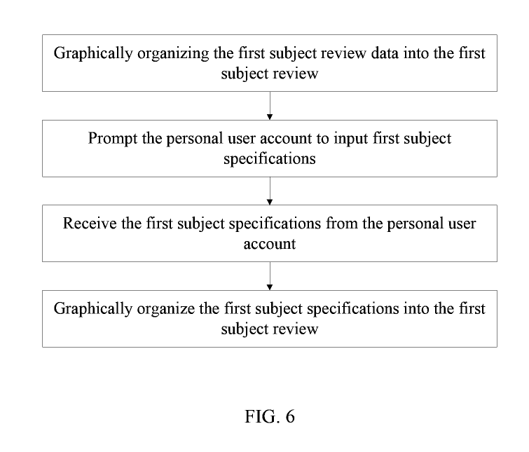

In reference to FIG. 6, the second method of gathering the first subject specifications 64 includes the at least one host server 12 prompting the personal user account 42 to input the first subject specifications 64. A plurality of first specification input fields is displayed to the user, allowing the user to submit information in regards to the dimensions of a product, location of a venue, etc. Upon receiving the first product specifications from the personal user account 42, the at least one host server 12 graphically organizes the first subject specifications 64 into the first review along with the first subject review data 63.

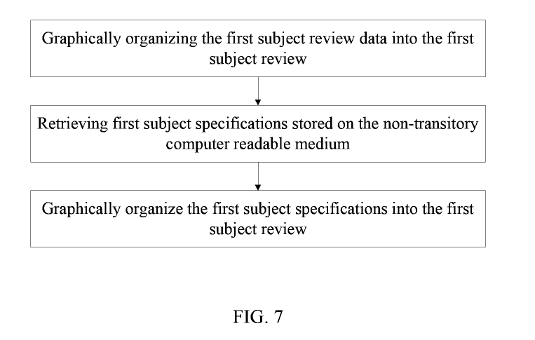

In reference to FIG. 7, in the third method of gathering the first subject specifications 64, both the first subject 61 and the first subject specifications 64 are stored on the at least one host server 12. When the first subject 61 is selected, the first subject 61 is retrieved along with the first subject specifications 64. Upon retrieving the first product specifications on the at least one host server 12, the at least one host server 12 graphically organizes the first subject specifications 64 into the first review along with the first subject review data 63.

In reference to FIG. 3a-3c, in addition to the first subject review 62, when creating the transit review 52, the user may also choose to include a second subject review 72 of the second subject 71. The second subject review 72 can also be displayed standalone. Upon selecting the second subject 71, the user is prompted to decide whether or not he or she would like to provide the second subject review 72. If the second subject 71 has already been reviewed by the user, either standalone or as part of another transit review 52, and the user elects to provide the second subject review 72, then the second subject review 72 is retrieved by the at least one host server 12. The second subject review 72 is then graphically organized into the transit review 52, along with the comparative review data 53. If the second subject review 72 does not exist and the user elects to provide the second subject review 72, then the personal user account 42 is prompted to input second subject review data 73 for the second subject 71.

The creation of the second subject review 72 is facilitated by the host website 21. A plurality of second review input fields is displayed to the user, allowing the user to submit second subject review data 73, such as the current date, a written description of the user's experience with the second subject 71, and an overall second subject 71 rating. In the preferred embodiment of the present invention, the overall second subject 71 rating is provided using a scale from one to five, however, it is possible for any other scale or rating method to be used. It is also possible for the plurality of second review input fields to be provided for the inclusion of any other relevant information in regards to the user's experience with the second subject 71.

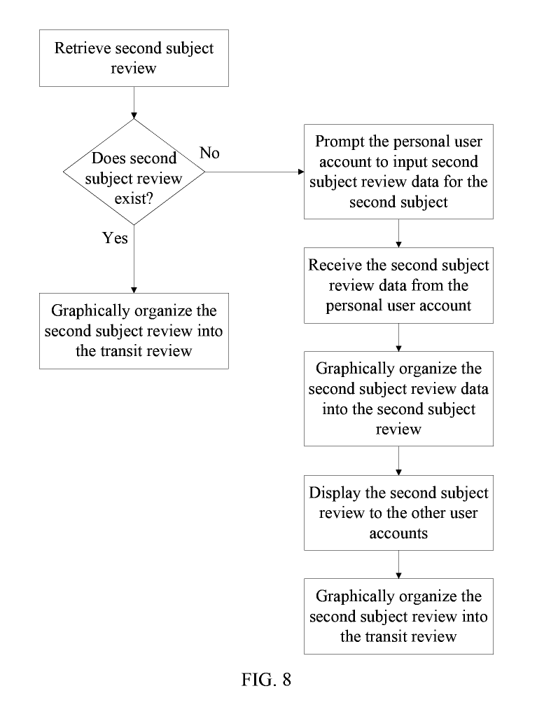

In reference to FIG. 8, upon receiving the second subject review data 73 for the second subject 71 from the personal user account 42, the at least one host server 12 graphically organizes the second subject review data 73 into the second subject review 72. The second subject review 72 is then displayed to the other user accounts 43, as depicted in FIG. 12c. The user may elect to share the second subject review 72 with all other users of the social transit review 52 platform or only with the select group of friends on the friends list of the user. Once the second subject review 72 has been shared, the other users can comment on the second subject review 72 and provide an overall rating for the second subject review 72. In the preferred embodiment of the present invention, the transit review includes the first subject review, the second subject review, and the comparative review data for the first subject and the second subject, as depicted in FIG. 12a.

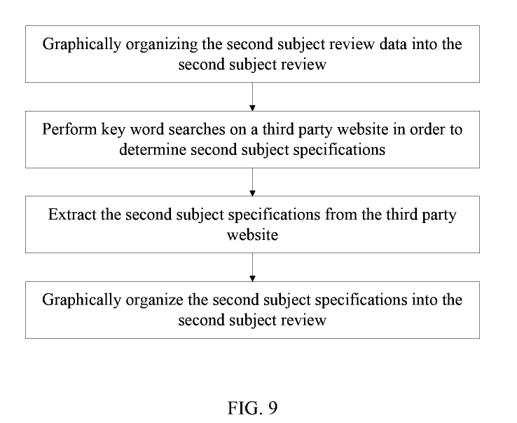

When creating the second subject review 72, second subject specifications 74 may also be gathered and employed. The at least one host server 12 graphically organizes the second subject specifications 74 into the second subject review 72 along with the second subject review data 73. Similar to the first subject specifications 64, the second subject specifications 74 can be gathered in three ways. In reference to FIG. 9, the first method of gathering the second subject specifications 74 includes performing key word searches on a third party website in order to determine the first subject specifications 64. When the second subject 71 is discovered on the third party website, the key word searches are performed in order to determine the second subject specifications 74 that are desired, such as the dimensions of a product, location of a venue, or service radius of a business. Once keywords are discovered, the at least one host server 12 extracts the second subject specifications 74 from the third party website and graphically organizes the second subject specifications 74 into the second review along with the second subject review data 73.

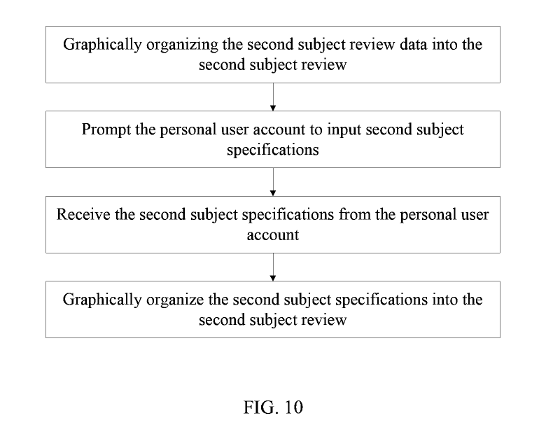

In reference to FIG. 10, the second method of gathering the second subject specifications 74 includes the at least one host server 12 prompting the personal user account 42 to input the second subject specifications 74. A plurality of second specification input fields is displayed to the user, allowing the user to submit information in regards to the dimensions of a product, location of a venue, etc. Upon receiving the second product specifications from the personal user account 42, the at least one host server 12 graphically organizes the second subject specifications 74 into the second review along with the second subject review data 73.

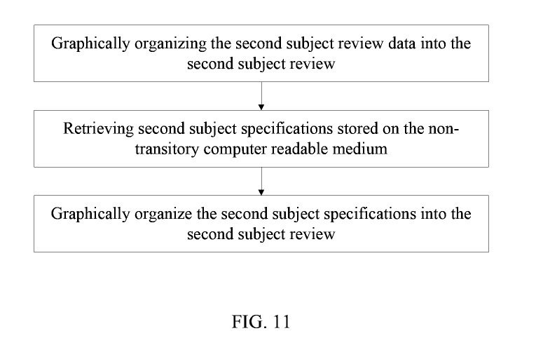

In reference to FIG. 11, in the third method of gathering the second subject specifications 74, both the second subject 71 and the second subject specifications 74 are stored on the at least one host server 12. When the second subject 71 is selected, the second subject 71 is retrieved along with the second subject specifications 74. Upon retrieving the second product specifications on the at least one host server 12, the at least one host server 12 graphically organizes the second subject specifications 74 into the second review along with the second subject review data 73.

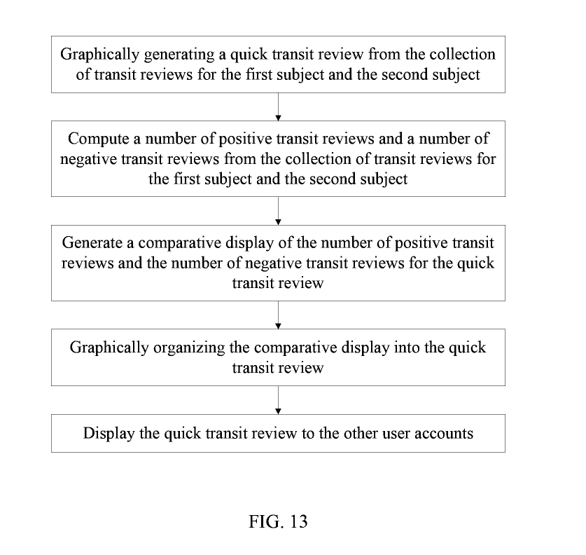

In reference to FIG. 13, a quick transit review 81 for the first subject 61 and the second subject 71 can also be created in order to provide a consensus on the transition experience from the first subject 61 to the second subject 71, or vice versa. As such, the quick transit review 81 is graphically generated from the collection of transit reviews 51 for the first subject 61 and the second subject 71. The at least one host server 12 computes a number of positive transit reviews 82 and a number of negative transit reviews 83 from the collection of transit reviews 51 for the first subject 61 and the second subject 71. The at least one host server 12 then generates a comparative display 84 of the number of positive transit reviews 82 and the number of negative transit reviews 83 for the quick transit review 81. Once the comparative display 84 has been generated, the comparative display 84 is graphically organized into the quick transit review 81, and the quick transit review 81 is then displayed to the other user accounts 43.

In the preferred embodiment of the present invention, the number of positive transit reviews 82 and the number of negative transit reviews 83 are computed using the overall transition rating of each transit review 52. Using the scale from one to five: if the overall transition rating is two and one half or more, then the transit review 52 is counted towards the number of positive transit reviews 82. If the overall transition rating is less than two and one half, then the transit review 52 is counted towards the number of negative transit reviews 83. In another embodiment of the present invention, the user indicates a positive or negative transit review 52 through one of the plurality of transition input fields. In yet another embodiment of the present invention, the number of positive transit reviews 82 and the number of negative transit reviews 83 are computed using the overall first subject 61 rating and the overall second subject 71 rating. It is also possible for the number of positive transit reviews 82 and the number of negative transit reviews 83 to be computed in any other number of ways.

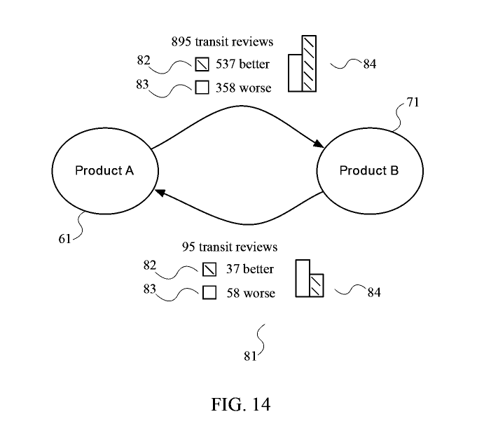

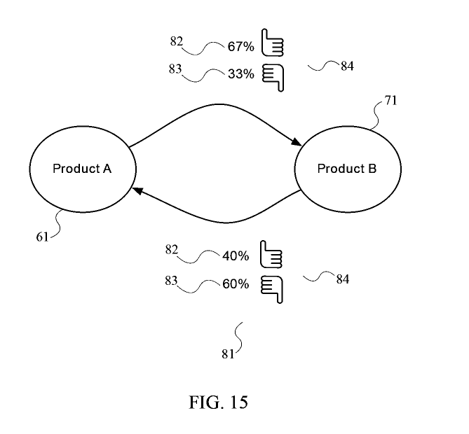

In reference to FIG. 14, as one example of the comparative display 84 to be used, the first subject 61 is depicted as product A, while the second subject 71 is depicted as product B. In the given example the number of positive transit reviews 82 and the number of negative transit reviews 83 are shown for both the transition from product A to product B and the transition from product B to product A. The number of positive transit reviews 82 is displayed in green (depicted by the shaded boxes), indicating that the user prefers the new product. The number of negative transit reviews 83 are displayed in red (depicted by the un-shaded boxes), indicating that the user prefers the old product. A color coded bar graph is also displayed alongside the colored number totals. In reference to FIG. 15, in another example of the comparative display 84 to be used, a thumbs up icon along with a percentage number is used to display the number of positive transit reviews 82, while a thumbs down icon along with a percentage number is used to display the number of negative transit reviews 83. This method more readily shows the ratio of the number of positive transit reviews 82 to the number of negative transit reviews 83, as opposed to exact values.

The user can also search for the first subject review 62, the second subject review 72, or the transit review 52 created by the other users of the social transit review 52 platform. At least one search input field is provided and used to locate individual product/service/venue reviews and transit reviews for specific products/services/venues. A plurality of search filters are also provided, such that the user can filter search results according to various traits such as relevance, date published, transition rating, etc. The user can then select the desired transit review 52 according to their search criteria.

Although the invention has been explained in relation to its preferred embodiment, it is to be understood that many other possible modifications and variations can be made without departing from the spirit and scope of the invention as hereinafter claimed.

What is claimed is:

1. A method of creating and sharing subject reviews by executing computer-executable instructions stored on a non-transitory computer-readable medium, the method comprises the steps of:
providing a plurality of user accounts and a collection of transit reviews;
prompting a personal user account from the plurality of user accounts to select a first subject and a second subject, wherein the first subject and the second subject are within the same scope of discussion;
prompting the personal user account to qualitatively compare the first subject and the second subject;
receiving comparative review data between the first subject and the second subject from the personal user account;
graphically organizing the comparative review data into a transit review;
displaying the transit review to other user accounts;
adding the transit review to the collection of transit reviews for the first subject and the second subject;
graphically generating a quick transit review from the collection of transit reviews for the first subject and the second subject; and
displaying the quick transit review to the other user accounts.

2. The method of creating and sharing subject reviews by executing computer-executable instructions stored on a non-transitory computer-readable medium, the method as claimed in claim 1 further comprises the steps of:
retrieving a first subject review for the first subject; and
graphically organizing the first subject review into the transit review.

3. The method of creating and sharing subject reviews by executing computer-executable instructions stored on a non-transitory computer-readable medium, the method as claimed in claim 2 further comprises the steps of:
prompting the personal user account to input first subject review data for the first subject,
if the first subject review does not exist;
receiving the first subject review data from the personal user account;
graphically organizing the first subject review data into the first subject review; and
displaying the first subject review to the other user accounts.

4. The method of creating and sharing subject reviews by executing computer-executable instructions stored on a non-transitory computer-readable medium, the method as claimed in claim 3 further comprises the steps of:
performing key word searches on a third party website in order to determine first subject specifications;
extracting the first subject specifications from the third party website; and
graphically organizing the first subject specifications into the first subject review.

5. The method of creating and sharing subject reviews by executing computer-executable instructions stored on a non-transitory computer-readable medium, the method as claimed in claim 3 further comprises the steps of:
prompting the personal user account to input first subject specifications;
receiving the first subject specifications from the personal user account; and
graphically organizing the first subject specifications into the first subject review.

6. The method of creating and sharing subject reviews by executing computer-executable instructions stored on a non-transitory computer-readable medium, the method as claimed in claim 3 further comprises the steps of:
retrieving first subject specifications stored on the non-transitory computer-readable medium; and
graphically organizing the first subject specifications into the first subject review.

7. The method of creating and sharing subject reviews by executing computer-executable instructions stored on a non-transitory computer-readable medium, the method as claimed in claim 1 further comprises the steps of:
retrieving a second subject review for the second subject; and
graphically organizing the second subject review into the transit review.

8. The method of creating and sharing subject reviews by executing computer-executable instructions stored on a non-transitory computer-readable medium, the method as claimed in claim 7 further comprises the steps of:
prompting the personal user account to input second subject review data for the second subject,
if the second subject review does not exist;
receiving the second subject review data from the personal user account;
graphically organizing the second subject review data into the second subject review; and
displaying the second subject review to the other user accounts.

9. The method of creating and sharing subject reviews by executing computer-executable instructions stored on a non-transitory computer-readable medium, the method as claimed in claim 8 further comprises the steps of:
performing key word searches on a third party website in order to determine second subject specifications;
extracting the second subject specifications from the third party website; and
graphically organizing the second subject specifications into the second subject review.

10. The method of creating and sharing subject reviews by executing computer-executable instructions stored on a non-transitory computer-readable medium, the method as claimed in claim 8 further comprises the steps of:
prompting the personal user account to input second subject specifications;
receiving the second subject specifications from the personal user account; and
graphically organizing the second subject specifications into the second subject review.

11. The method of creating and sharing subject reviews by executing computer-executable instructions stored on a non-transitory computer-readable medium, the method as claimed in claim 8 further comprises the steps of:
retrieving second subject specifications stored on the non-transitory computer-readable medium; and
graphically organizing the second subject specifications into the second subject review.

12. The method of creating and sharing subject reviews by executing computer-executable instructions stored on a non-transitory computer-readable medium, the method as claimed in claim 1 further comprises the steps of:
computing a number of positive transit reviews and a number of negative transit reviews from the collection of transit reviews for the first subject and the second subject;
generating a comparative display of the number of positive transit reviews and the number of negative transit reviews for the quick transit review; and
graphically organizing the comparative display into the quick transit review.

13. A method of creating and sharing subject reviews by executing computer-executable instructions stored on a non-transitory computer-readable medium, the method comprises the steps of:
providing a plurality of user accounts and a collection of transit reviews;
prompting a personal user account from the plurality of user accounts to select a first subject;
prompting the personal user account to input first subject review data for the first subject;
receiving the first subject review data from the personal user account;
graphically organizing the first subject review data into a first subject review;
displaying the first subject review to other user accounts;
prompting the personal user account to select a second subject, wherein the second subject is within the same scope of discussion as the first subject;
prompting the personal user account to input second subject review data for the second subject;
receiving the second subject review data from the personal user account;
graphically organizing the second subject review data into a second subject review;
displaying the second subject review to the other user accounts;
prompting the personal user account to qualitatively compare the first subject and the second subject;
receiving comparative review data between the first subject and the second subject from the personal user account;
graphically organizing the comparative review data, the first subject review, and the second subject review into a transit review;
displaying the transit review to the other user accounts;
adding the transit review to the collection of transit reviews for the first subject and the second subject;
graphically generating a quick transit review from the collection of transit reviews for the first subject and the second subject; and
displaying the quick transit review to the other user accounts.

14. The method of creating and sharing subject reviews by executing computer-executable instructions stored on a non-transitory computer-readable medium, the method as claimed in claim 13 further comprises the steps of:
performing key word searches on a third party website in order to determine first subject specifications;
extracting the first subject specifications from the third party website; and
graphically organizing the first subject specifications into the first subject review.

15. The method of creating and sharing subject reviews by executing computer-executable instructions stored on a non-transitory computer-readable medium, the method as claimed in claim 13 further comprises the steps of:
prompting the personal user account to input first subject specifications;
receiving the first subject specifications from the personal user account; and
graphically organizing the first subject specifications into the first subject review.

16. The method of creating and sharing subject reviews by executing computer-executable instructions stored on a non-transitory computer-readable medium, the method as claimed in claim 13 further comprises the steps of:
retrieving first subject specifications stored on the non-transitory computer-readable medium; and
graphically organizing the first subject specifications into the first subject review.

17. The method of creating and sharing subject reviews by executing computer-executable instructions stored on a non-transitory computer-readable medium, the method as claimed in claim 13 further comprises the steps of:
performing key word searches on a third party website in order to determine second subject specifications;
extracting the second subject specifications from the third party website; and
graphically organizing the second subject specifications into the second subject review.

18. The method of creating and sharing subject reviews by executing computer-executable instructions stored on a non-transitory computer-readable medium, the method as claimed in claim 13 further comprises the steps of:
prompting the personal user account to input second subject specifications;
receiving the second subject specifications from the personal user account; and
graphically organizing the second subject specifications into the second subject review.

19. The method of creating and sharing subject reviews by executing computer-executable instructions stored on a non-transitory computer-readable medium, the method as claimed in claim 13 further comprises the steps of:
retrieving second subject specifications stored on the non-transitory computer-readable medium; and
graphically organizing the second subject specifications into the second subject review.

20. The method of creating and sharing subject reviews by executing computer-executable instructions stored on a non-transitory computer-readable medium, the method as claimed in claim 13 further comprises the steps of:
computing a number of positive transit reviews and a number of negative transit reviews from the collection of transit reviews for the first subject and the second subject;
generating a comparative display of the number of positive transit reviews and the number of negative transit reviews for the quick transit review; and
graphically organizing the comparative display into the quick transit review.
